(19) United States
(12) Patent Application Publication
(10) Pub. No.: US 2014/0203569 A1
(43) Pub. Date: Jul. 24, 2014

(54) ADJUSTABLE DOOR LOCK AND ASSOCIATED METHOD

(71) Applicant: Jason L. Stile, Katonah, NY (US)

(72) Inventor: Jason L. Stile, Katonah, NY (US)

(21) Appl. No.: 14/222,053

(22) Filed: Mar. 21, 2014

Related U.S. Application Data
(63) Continuation-in-part of application No. PCT/US13/63602, filed on Oct. 5, 2013.
Application No. PCT/US13/63602 is a continuation of application No. 14/046,964, filed on Oct. 5, 2013.
Application No. 14/046,964 is a continuation-in-part of application No. 12/955,552, filed on Nov. 29, 2010.
(60) Provisional application No. 61/264,896, filed on Nov. 30, 2009.

(30) Foreign Application Priority Data
Oct. 5, 2013 (US) PCT/US13/63602

(51) Int. Cl. E05C 1/00

(52) U.S. Cl. CPC E05C 1/004
USPC 292/137

(57) ABSTRACT

An adjustable door lock, for locking a misaligned or off-set door relative to support wall adjacent to the door, includes a catch plate, a catch having a channel wherein the catch is adjustably communicated with the catch plate, a support plate, and a locking bolt in communication with the support plate wherein the locking bolt is reciprocated along a first path traveling along the support plate and the channel. Advantageously, as the locking bolt ingresses the channel, the catch is automatically adjusted along a second path registered non-parallel to the first path such that the channel is automatically aligned with the first path.

### CROSS REFERENCE TO RELATED APPLICATIONS

This application is a continuation-in-part application of currently pending Patent Cooperation Treaty (PCT) international patent application PCT/US2013/063602, filed Oct. 5, 2013, which claims the benefit and priority of currently pending U.S. patent application Ser. No. 14/046964, filed Oct. 5, 2013, which is a continuation-in-part application of currently pending U.S. patent application Ser. No. 12/955,552 filed Nov. 29, 2010, which claims the benefit and priority of U.S. provisional application No. 61/264896 filed Nov. 30, 2009, now abandoned, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE DISCLOSURE

1. Technical Field

This disclosure relates to door locks and, more particularly, to an adjustable door lock for providing users with an easy and convenient means of locking offset and misaligned doors.

2. Prior Art

A barrel bolt is a sliding lock mechanism used to provide security for both average and heavy weight doors and windows. The bolt is surface mounted where the bolt slides into a catch on the other side of the door. Barrel bolts are most suitable for single leaf doors and passive leaf of double doors. They find wide application throughout industry and commerce; especially where a high level of physical security is required. These bolts are easy to fit and are available in a wide range of sockets. Some barrel bolts have spring action to hold the bolt in place while some others are lockable. These bolts are available in various sizes and come in various decorative finishes and with surface or universal strikes. Some barrel bolts are plain, simple looking while some others are highly decorative which are just perfect for installing on cabinet doors, windows etc.

Barrel bolts are installed on a variety of doors, and require high degree accuracy on installation, so that the bolt and catch align when engaged. Even when installed properly, the bolt and catch will become misaligned as the door and wall of the building shifts through use. This issue is common among barrel bolts, and to fix the issue homeowners or leasing managers must re-position the barrel bolt to realign, or find another inconvenient means of remedy. Usually either the lock or the catch has to be removed and the door and wall may require some annoying cosmetic repairs.

Through the effects of temperature fluctuations and structural stresses induced when constructing a building, there is a tendency for the doors of buildings to shift from their original positions thus causing these doors to be misaligned with its frame over time. The shifting may cause the locking bolts and catches of these doors to be misaligned thereby causing the doors to be unboltable.

Accordingly, a need remains for a device in order to overcome the above-noted shortcomings. The present disclosure satisfies such a need by providing an adjustable door lock that is convenient and easy to use, lightweight yet durable in design, versatile in its applications, and designed for providing an easy means of locking offset and misaligned doors. In particular, the advantageous structural configuration of the present disclosure disclosed provides the unexpected and unpredictable advantage of automatically aligning the locking bolt to the catch of these misaligned doors without the need for removing and refitting the locking bolt or catch.

### BRIEF SUMMARY OF THE DISCLOSURE

In view of the foregoing background, it is therefore an object of the present disclosure to provide an apparatus for locking a misaligned or off-set door relative to support wall adjacent to the door. These and other objects, features, and advantages of the disclosure are provided by an adjustable door lock including a catch plate, a catch having a channel wherein the catch is adjustably communicated with the catch plate, a support plate, and a locking bolt in communication with the support plate wherein the locking bolt is reciprocated along a first path traveling along the support plate and the channel. Advantageously, as the locking bolt ingresses the channel, the catch is automatically adjusted along a second path registered non-parallel to the first path such that the channel is automatically aligned with the first path.

In a non-limiting exemplary embodiment, the first path is linear.

In a non-limiting exemplary embodiment, the second path is linear.

In a non-limiting exemplary embodiment, the catch plate has a body and a plurality of flanges positioned on an exterior face of the body such that a corresponding gap is formed between the body and each of the flanges, respectively.

In a non-limiting exemplary embodiment, the catch is selectively interfitted through at least of one of the gaps while the catch is automatically aligned with the first path.

In a non-limiting exemplary embodiment, the locking bolt includes a first portion and a second portion spaced therefrom wherein the first portion and second portion are aligned along the first path. An intermediary portion is engaged with the first portion and the second portion. Such an intermediary portion is offset from the first path and provided with a centrally registered longitudinal axis registered substantially orthogonal to the first path.

In a non-limiting exemplary embodiment, the support plate includes a wall, a first flange and a second flange outwardly extending from the wall and traversing the first path. The first flange has a first aperture and the second flange has a second aperture axially opposed from the first aperture. In this manner, the first aperture and the second aperture receive the first portion and the second portion of the locking bolt, respectively. A first stop and a second stop outwardly extend from the wall wherein each of the first stop and the second stop traverse a travel path of the intermediary portion when the locking bolt is disposed at a vertically lowered position.

In a non-limiting exemplary embodiment, the intermediary portion has a curvilinear shape at least partially positioned along one of the first stop and the second stop.

In a non-limiting exemplary embodiment, the locking bolt is selectively rotated about an axis aligned with the first path such that the intermediary portion is selectively articulated away from the first stop and the second stop.

In a non-limiting exemplary embodiment, the intermediary portion is at locked and unlocked positions when registered substantially parallel and substantially orthogonal to the wall, respectively.

In a non-limiting exemplary embodiment, the first flange and the second flange are spaced apart by a first distance. The first stop and second stop are spaced apart by a second distance. Notably, the first distance does not equal the second distance.

In a non-limiting exemplary embodiment, when the intermediary portion is registered substantially orthogonal to the wall, the intermediary portion is freely reciprocated along an entire length of the first distance.

In a non-limiting exemplary embodiment, when the intermediary portion is registered substantially parallel to the wall and below the first flange and second flange, the intermediary portion is freely reciprocated along the second distance and prohibited from traveling along the entire length of the first distance.

In a non-limiting exemplary embodiment, the first path is bi-directional and oriented along a horizontal plane while the second path is bi-directional and oriented along a vertical plane.

In a non-limiting exemplary embodiment, the locking bolt linearly traverses the second path upon ingressing and egressing the channel respectively.

In a non-limiting exemplary embodiment, the catch flanges remain statically mated to the catch plate as the catch is displaced along the second path.

In a non-limiting exemplary embodiment, the catch includes a plurality of guides diverging away from the channel towards the support plate for guiding the locking bolt along the channel.

In a non-limiting exemplary embodiment, the guides converge towards the channel away from the support plate for guiding the locking bolt along the channel.

The present disclosure further includes a method for using an adjustable door lock for locking a misaligned or off-set door relative to a support wall adjacent to the door. Such a method includes the steps of: providing a catch plate; providing a catch having a channel; adjustably communicating the catch with the catch plate; providing a support plate; and providing and communicating a locking bolt with the support plate.

The method further includes the steps of: reciprocating the locking bolt along a first path traveling along the support plate and the channel; and the locking bolt ingressing the channel and thereby automatically adjusting the catch along a second path registered non-parallel to the first path such that the channel automatically aligns with the first path.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the disclosure of the application, which is measured by the claims, nor is it intended to be limiting as to the scope of the disclosure in any way.

### BRIEF DESCRIPTION OF THE SEVERAL VIEWS OF THE DRAWING

The novel features believed to be characteristic of this disclosure are set forth with particularity in the appended claims. The disclosure itself, however, both as to its organization and method of operation, together with further objects and advantages thereof, may best be understood by reference to the following description taken in connection with the accompanying drawings in which:

FIG. 1 is a perspective view showing an adjustable door lock in a locked position, in accordance with one embodiment of the present disclosure, wherein brackets are removably mated to the catch plate;

FIG. 2 is an exploded view of the adjustable door lock shown at an unlocked position;

FIG. 3 is an exploded view of the adjustable door lock shown in FIG. 1;

FIG. 4 is a front elevational view of the adjustable door lock showing the catch upwardly aligned relative to the locking bolt;

FIG. 5 is front elevational view of the adjustable door lock showing the catch downwardly aligned relative to the locking bolt;

FIG. 6 is a perspective view showing an adjustable door lock in a locked position, in accordance with one embodiment of the present disclosure, wherein the catch plate has flanges folded thereover in lieu of employing removable brackets;

FIG. 7 is an exploded view of the adjustable door lock shown at an unlocked position;

FIG. 8 is an exploded view of the adjustable door lock shown in FIG. 1;

FIG. 9 is a front elevational view of the adjustable door lock showing the catch upwardly aligned relative to the locking bolt;

FIG. 10 is front elevational view of the adjustable door lock showing the catch downwardly aligned relative to the locking bolt;

FIG. 11 is a perspective view showing an adjustable door lock in a locked position, in accordance with one embodiment of the present disclosure, wherein a sliding bolt has an axial offset intermediary portion positioned adjacent to a first stop of a door plate;

FIG. 12 is a partially exploded view of the adjustable door lock shown in FIG. 11;

FIG. 13 is side elevational view of the adjustable door lock shown in FIG. 11, wherein the intermediary portion of the sliding bolt is disposed between the first stop and a second stop of the door plate;

FIG. 14 is side elevational view of the adjustable door lock shown in FIG. 11, wherein the intermediary portion of the sliding bolt is positioned adjacent to a first stop of a door plate;

FIG. 15 is an exploded view of the adjustable door lock shown in FIG. 11;

FIG. 16 is side elevational view of the adjustable door lock shown in FIG. 12, wherein the sliding bolt is rotated approximately 90 degrees about a longitudinal axis thereof such that the chamfered end upwardly displaces the catch while the sliding bolt enters the channel; and

FIG. 17 is side elevational view of the adjustable door lock, wherein opposed chamfered ends of the sliding bolt are frictionally abutted against axially offset catches situated at opposed lateral sides of the door plate, respectively, in accordance with one embodiment of the present disclosure.

Those skilled in the art will appreciate that the figures are not intended to be drawn to any particular scale; nor are the figures intended to illustrate every embodiment of the disclosure. The disclosure is not limited to the exemplary embodiments depicted in the figures or the shapes, relative sizes or proportions shown in the figures.

### DETAILED DESCRIPTION OF THE DISCLOSURE

The present disclosure will now be described more fully hereinafter with reference to the accompanying drawings, in which a preferred embodiment of the disclosure is shown. This disclosure may, however, be embodied in many different forms and should not be construed as limited to the embodiment set forth herein. Rather, this embodiment is provided so that this application will be thorough and complete, and will fully convey the true scope of the disclosure to those skilled in the art. Like numbers refer to like elements throughout the figures.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “present disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The below disclosed subject matter is to be considered illustrative, and not restrictive, and the appended claims are intended to cover all such modifications, enhancements, and other embodiments which fall within the true scope of the present disclosure. Thus, to the maximum extent allowed by law, the scope of the present disclosure is to be determined by the broadest permissible interpretation of the following claims and their equivalents, and shall not be restricted or limited by the foregoing detailed description.

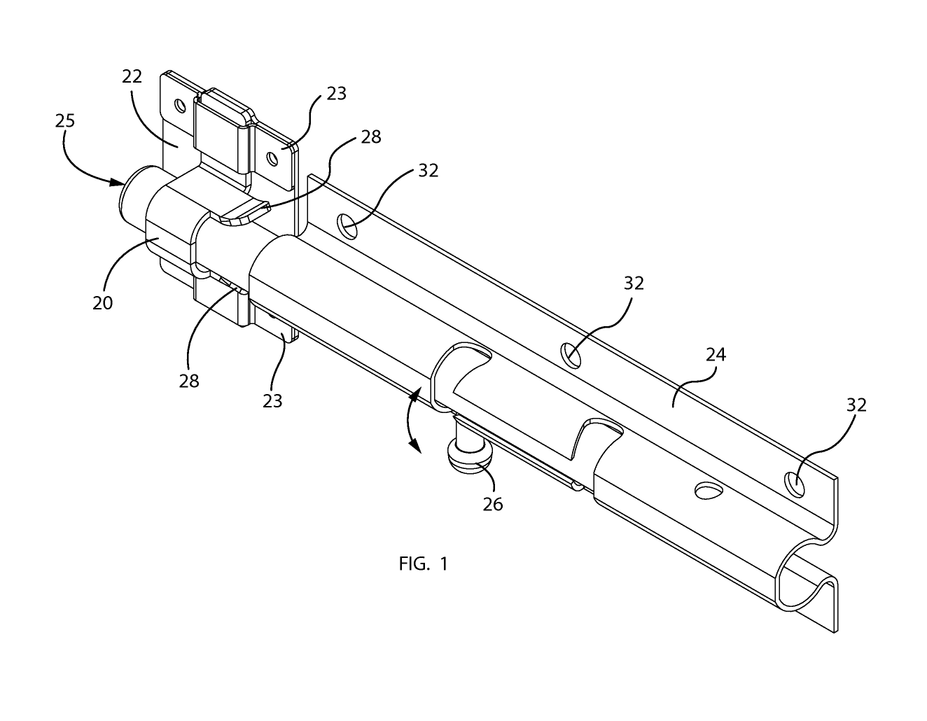

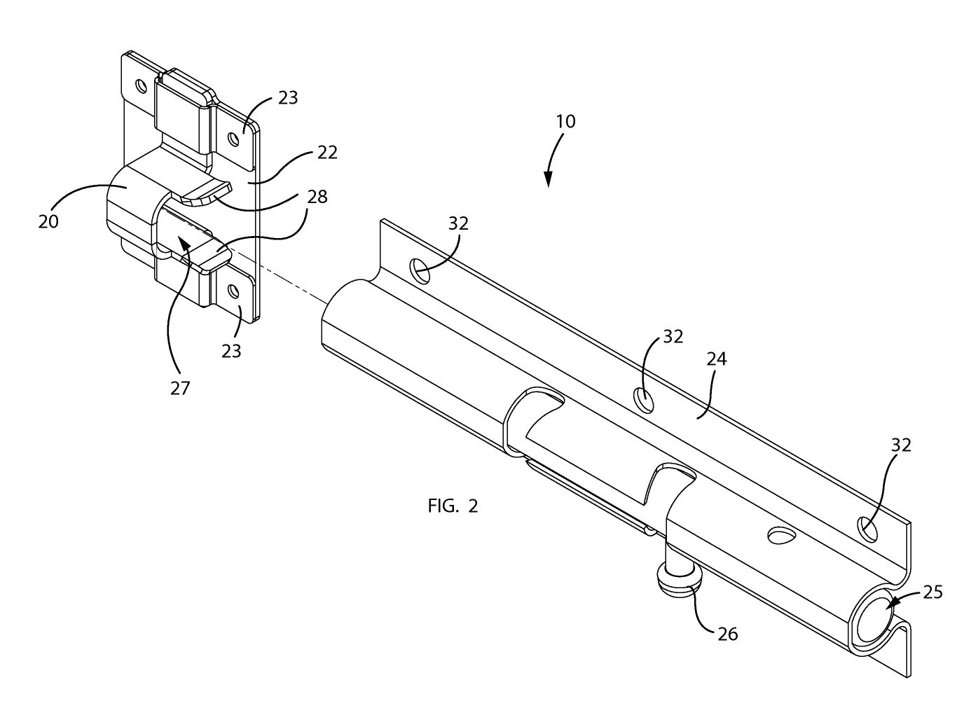

The device of this disclosure is referred to generally in FIGS. 1-5 and is intended to provide an adjustable door lock. It should be understood that the present disclosure may be used to provide a door lock for off-set and misaligned doors as well as different types of movable barriers, and should not be limited to the uses described herein. It is noted that “door plate” and “bolt plate” and “support plate” are interchangeably used throughout the disclosure. For example, the “support plate” may be affixed to a door or a support wall (e.g., door frame, dray wall, etc.) adjacent to the door. Likewise, the catch plate may be affixed to a door or a support wall (e.g., door frame, dray wall, etc.) adjacent to the door.

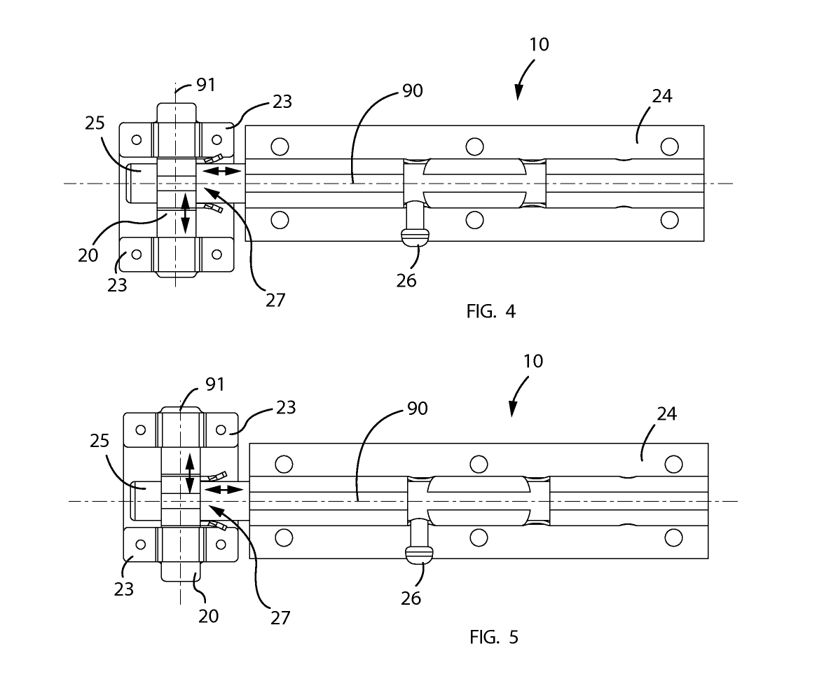

Referring to FIGS. 1-5, the adjustable door lock 10 may include a catch plate 22 adapted to be secured adjacent to a door (not shown), such as a wall or a portion of a door frame. A plurality of catch brackets 23 may be connected to the catch plate 22. A catch 20 may be adjustably connected to the catch plate 22 and interfitted through the catch brackets 23. Such a catch 20 preferably has a linear channel 27 formed therein. A door plate 24 may be disposed adjacent to the catch plate 22 and adapted to be secured to the door (not shown). As best shown in FIGS. 4 and 5, a locking bolt 25 may be housed within the door plate 24 and may be linearly reciprocated along a first linear path 90 passing through the door plate 24 and the linear channel 27. Such a structural arrangement provides the unpredicted and unexpected advantage of automatically adjusting the catch 20 along a second linear path 91 that is orthogonally registered relative to the first linear path 90 such that the linear channel 27 automatically becomes axially aligned with the locking bolt 25 as the locking bolt 25 ingresses and egresses the catch 20.

From exposure to temperature fluctuations and structural stresses during building construction, doors/frames shift from their original positions and thereby become misaligned over time. Such misalignment causes conventional locking bolts and catches to become misaligned thereby preventing easy locking/unlocking The present disclosure provides the unexpected and unpredictable advantage of automatically aligning the locking bolt 25 with the catch 20 during such misalignment without the need for removing and refitting the locking bolt 25 or catch 20.

Referring to FIGS. 4 and 5, the first linear path 90 may traverse the second linear path 91 and may be bi-directionally oriented along a horizontal plane while the second linear path 91 may be bi-directionally oriented along a vertical plane. In this way, the locking bolt 25 may linearly traverse the second linear path 91 upon ingressing and egressing the linear channel 27 respectively, while the catch brackets 23 remain statically mated to the catch plate 22 as the catch 20 is displaced along the second linear path 91. Such an arrangement provides the unexpected and unpredictable advantage of providing a self-adjusting catch 20 when a misaligned locking bolt 25 is inserted into its linear channel 27, without undesirably shifting the catch brackets 23.

Referring to FIGS. 1-3, the catch 20 may include a plurality of guides 28, diverging away from the linear channel 27 and towards the door plate 24 for guiding the locking bolt 25 along the linear channel 27. Such guides 28 preferably converge towards the linear channel 27 and away from the door plate 24 for guiding the locking bolt 25 along the linear channel 27. Such a structural arrangement provides the unexpected and unpredictable advantage of ensuring locking bolt 25 is smoothly guided into the catch 20 without requiring an added step of aligning the catch 20 to the locking bolt 25 by the user.

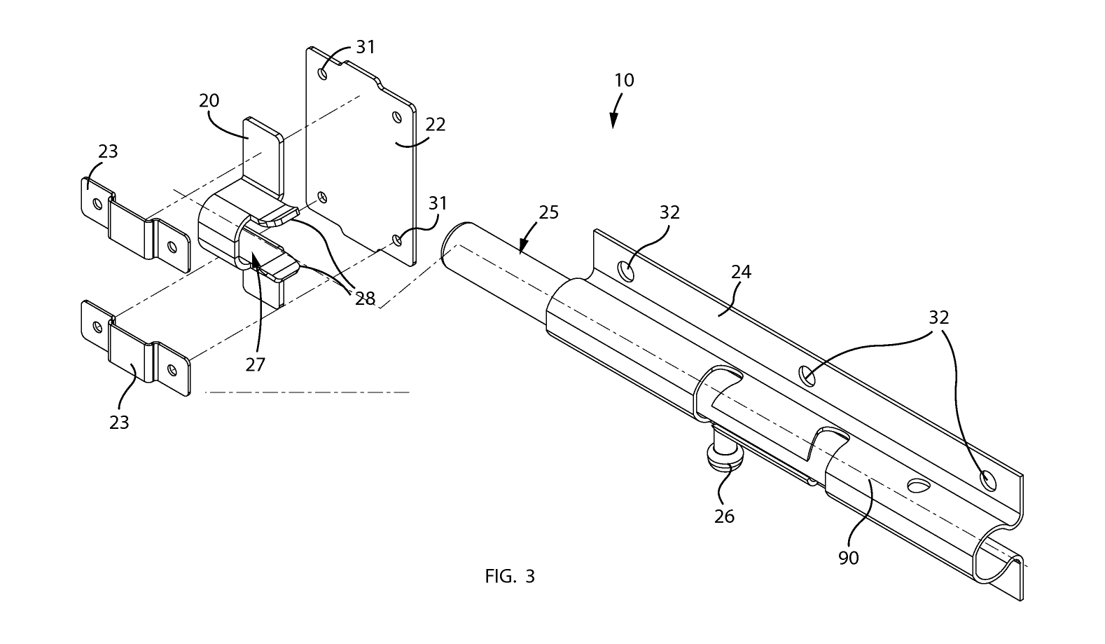

Referring to FIGS. 1-3 again, the locking bolt 25 may include a handle 26 such that locking bolt 25 may be rotated about the first linear path 90 (see FIG. 3) thereby displacing the handle 26 between locked and unlocked positions relative to the door plate 24. Such a structural arrangement provides the benefit of freely rotating locking bolt 25 while ingressed and egressed from linear channel 27.

The present disclosure may include a method of utilizing an adjustable door lock 10 for locking a misaligned or off-set door relative to support wall adjacent to the door. Such a method may include the chronological steps of: providing and securing a catch plate 22 adjacent to the door; providing a plurality of catch brackets 23; providing a catch 20 preferably having a linear channel 27 formed therein; connecting the catch brackets 23 to the catch plate 22; and adjustably connecting the catch 20 to the catch plate 22 by interfitting the catch 20 through the catch brackets 23.

Such a method may further include the chronological steps of: providing and disposing a door plate 24 adjacent to the catch plate 22; providing and housing a locking bolt 25 within the door plate 24; securing the door plate 24 to the door; linearly reciprocating the locking bolt 25 along a first linear path 90 passing through the door plate 24 and the linear channel 27; automatically adjusting the catch 20 along a second linear path 91 orthogonally registered relative to the first linear path 90 by ingressing and egressing the locking bolt 25 through the catch 20; and automatically and axially aligning the linear channel 27 with the locking bolt 25.

As a non-limiting exemplary embodiment, the catch plate 22 may further include a plurality of holes 31 such that a plurality of screws may be inserted to fixedly engage the catch plate 22 with a door frame. Guides 28 may extend outwardly from the linear channel 27 such that the distal end portions of the guides 28 may be wider than the linear channel 27. In this way, the guides 28 may form a generally “V” shaped path thereby enabling the locking bolt 25 to slidably enter the linear channel 27 and may easily secure the locking bolt 25 to a locked position. As noted hereinabove, catch 20 is slidably mated to the catch plate 22 by catch brackets 23 such that the catch 20 is automatically aligned with the locking bolt 25 even if there is a change in the door alignment relative to the linear channel 27.

As a non-limiting example, locking bolt 25 may be slidably enclosed within the linear channel 27 formed on the first linear path 90 of the door plate 24. The locking bolt handle 26 may be fixedly mated to the locking bolt 25 such that the handle 26 may be slidably engaged with the catch 20 in a locked and an unlocked position on the door plate 24. Referring to FIGS. 1-3, the door plate 24 may include a plurality of holes 32 that receive fasteners to engage the door plate 24 fixedly with a door.

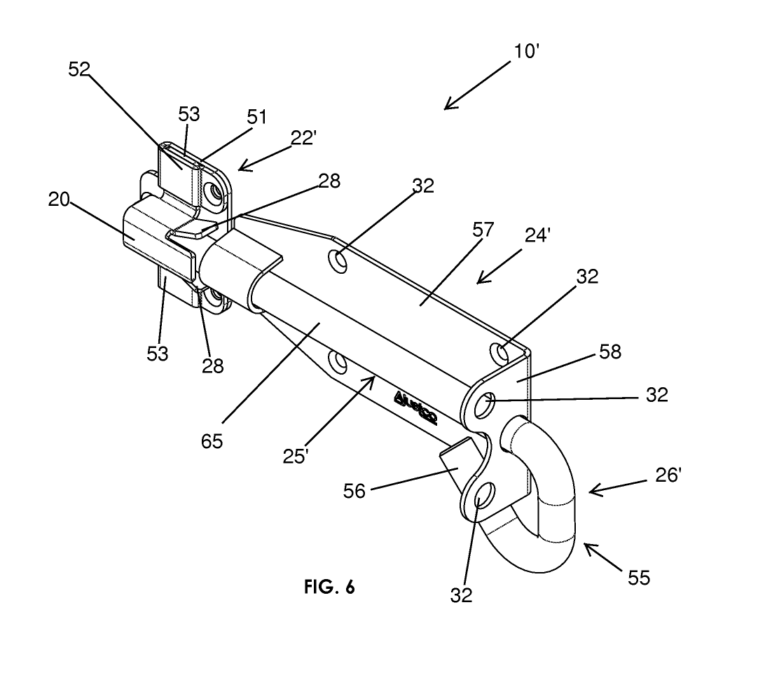

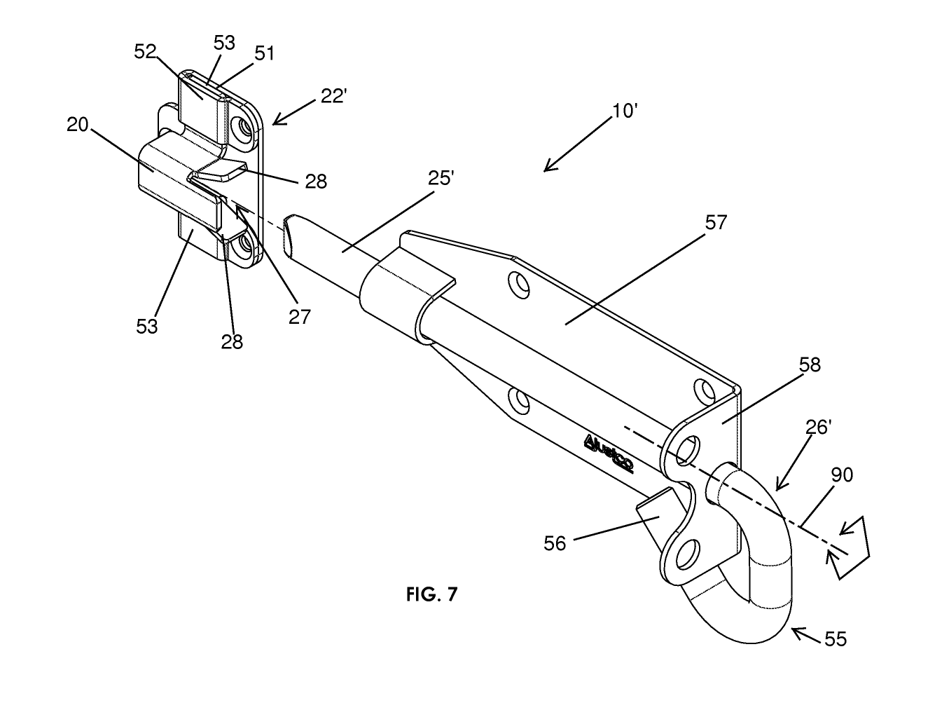

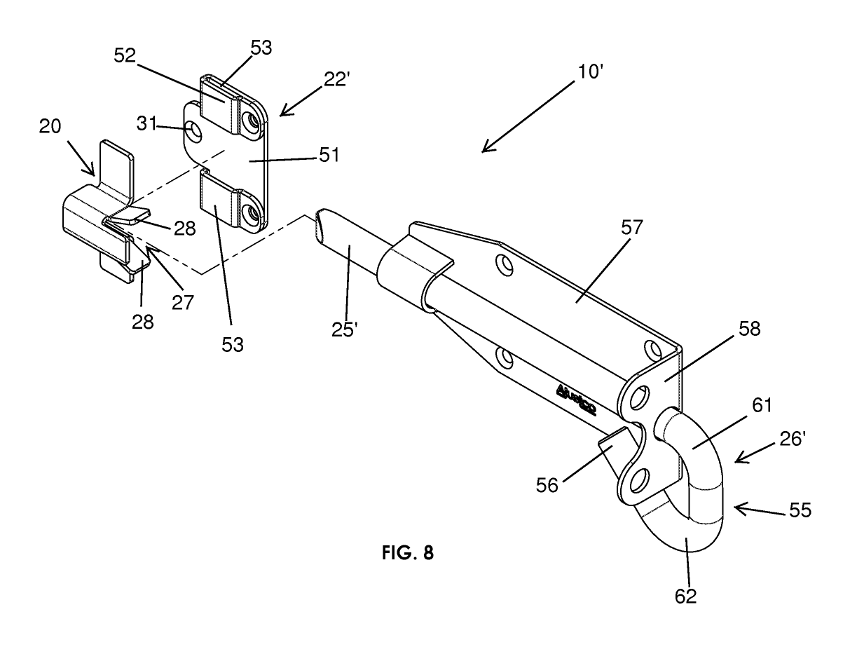

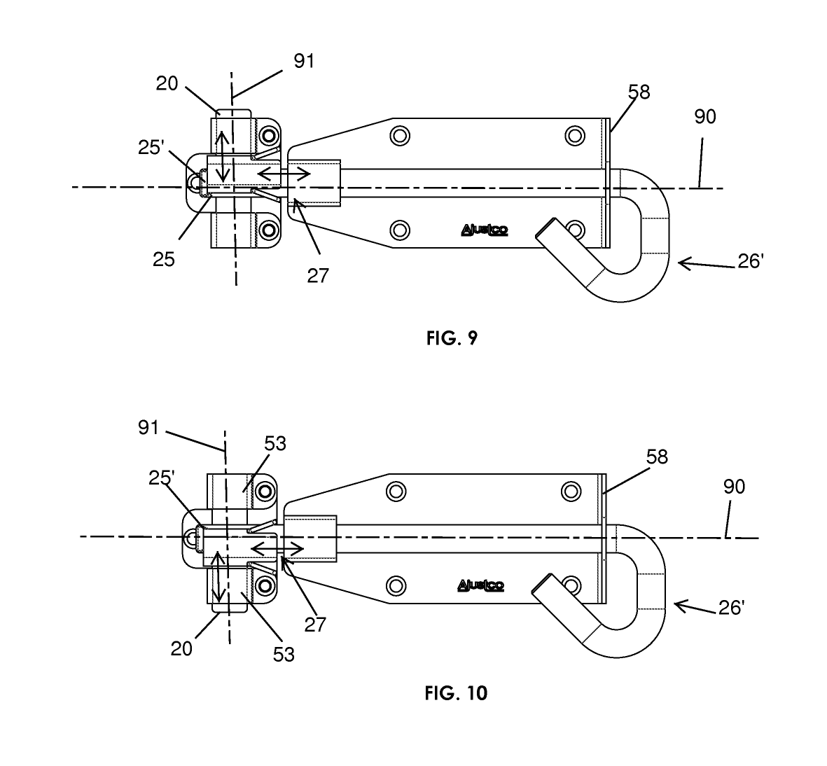

Referring to FIGS. 6-10, a non-limiting exemplary embodiment of the door lock 10′ replaces brackets 23 with a modified catch plate 22′ as explained hereinbelow. Also, the door plate 24′ and handle 26′ are modified to provide additional security. The modified catch plate 22′ has a body 51 and a plurality of flanges 52 positioned on an exterior face of the body 51 such that a corresponding gap 53 is formed between the body 51 and each of the flanges 52, respectively. Advantageously, a catch 20 having a channel 27 formed therein is adjustably connected to the catch plate 22′ and interfitted through at least of one of the gaps 53. A door plate 24′ is disposed adjacent to the catch plate 22′ and adapted to be secured to the door. A locking bolt 25′ is in communication with the door plate 24′ and linearly reciprocated along a first linear path 90 passing along the door plate 24′ and the channel 27. Notably, the catch 20 is automatically adjusted along a second linear path 91 orthogonally registered relative to the first linear path 90 such that the linear channel 27 automatically becomes axially aligned with the locking bolt 25′ as the locking bolt 25′ ingresses and egresses the catch 20.

Referring to FIGS. 6-10, in a non-limiting exemplary embodiment, the first linear path 90 is bi-directional and oriented along a horizontal plane while the second linear path 91 is bi-directional and oriented along a vertical plane.

Referring to FIGS. 6-10, in a non-limiting exemplary embodiment, the locking bolt 25′ linearly traverses the second linear path 91 upon ingressing and egressing the linear channel 27 respectively.

Referring to FIGS. 6-10, in a non-limiting exemplary embodiment, the flanges 52 remain statically mated to body 51 as the catch 20 is displaced along the second linear path 91.

Referring to FIGS. 6-10, in a non-limiting exemplary embodiment, the catch 20 includes a plurality of guides 28 diverging away from the linear channel 27 towards the door plate 24′ for guiding the locking bolt 25′ along the linear channel 27.

Referring to FIGS. 6-10, in a non-limiting exemplary embodiment, the guides 28 converge towards the linear channel 27 away from the door plate 24′ for guiding the locking bolt 25′ along the linear channel 27.

Referring to FIGS. 6-10, in a non-limiting exemplary embodiment, the locking bolt 25′ includes a handle 26′ located at a proximal end thereof. Such a handle 26′ is rotated about the first linear path 90 thereby displacing the handle 26′ between locked and unlocked positions relative to the door plate 24′.

Referring to FIGS. 6-10, in a non-limiting exemplary embodiment, the door plate 24′ includes a main section 57 registered generally parallel to a major longitudinal linear section 65 of the locking bolt 25′ and, an auxiliary section 58 is registered generally orthogonal to the main section 57. In this manner, the locking bolt 25′ is prohibited from axially reciprocating along the first linear path 90 when the handle 26′ is rotated subjacent to linear section 25.

Referring to FIGS. 6-10, in a non-limiting exemplary embodiment, the handle 26′ passes through the auxiliary section 58. Such a handle 26′ includes a first section 55 disposed proximal to the auxiliary section 58, and a second section 56 disposed distal to the auxiliary section 58. Advantageously, when the handle 26′ is disposed subjacent to the longitudinal linear section 65, the locking bolt 25′ is prohibited from axially sliding along the first linear path 90. The first section 55 may have at least one radius of curvature, while second section 56 may be linear. The auxiliary section 58 of door plate 24′ is aligned at a transition juncture between the first and second sections 55, 56 of the handle 26′.

Referring to FIGS. 6-10, in a non-limiting exemplary embodiment, a method for using an adjustable door lock for locking a misaligned or off-set door relative to a support wall adjacent to the door, is disclosed. Such a method includes the steps of: providing a catch plate 22′ adapted to be secured adjacent to the door wherein the catch plate 22′ has a body 51 and a plurality of flanges 52 positioned on an exterior face of the body 51 such that a corresponding gap 53 is formed between the body 51 and each of the flanges 52, respectively; and providing and adjustably connecting a catch 20 to the catch plate 22′ thereby interfitting the catch 20 through at least of one of the gaps 53. Such a catch 20 has a channel 27 formed therein.

Referring to FIGS. 6-10, the method further includes the steps of: providing and disposing a door plate 24′ adjacent to the catch plate 22′ wherein the door plate 24′ is adapted to be secured to the door; providing and communicating a locking bolt 25′ with the door plate 24′ such that the locking bolt 25′ is capable of being linearly reciprocated along a first linear path 90 passing along the door plate 24′ and the channel 27; and automatically adjusting the catch 20 along a second linear path 91 orthogonally registered relative to the first linear path 90 such that the linear channel 27 automatically becomes axially aligned with the locking bolt 25′ as the locking bolt 25′ ingresses and egresses the catch 20.

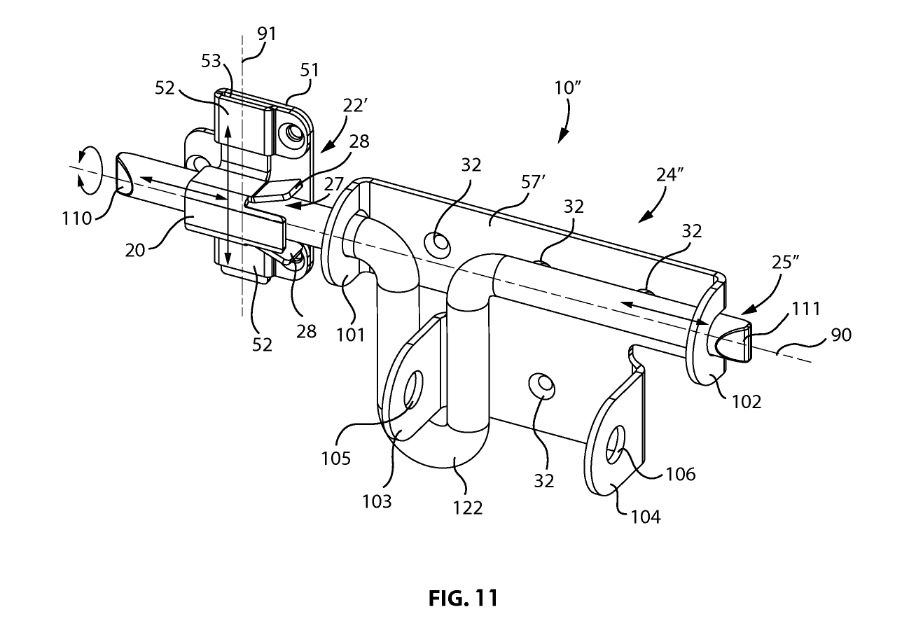

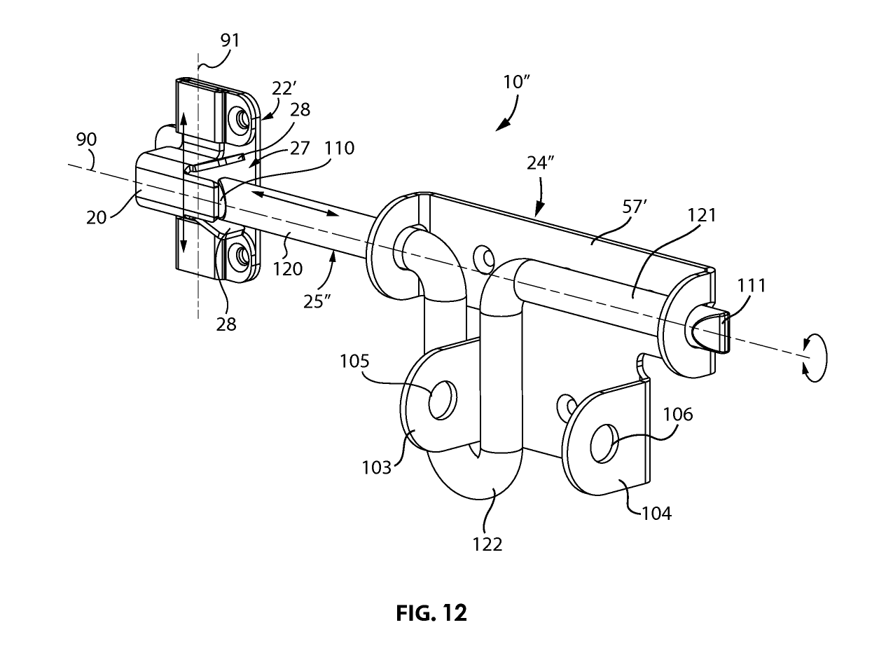

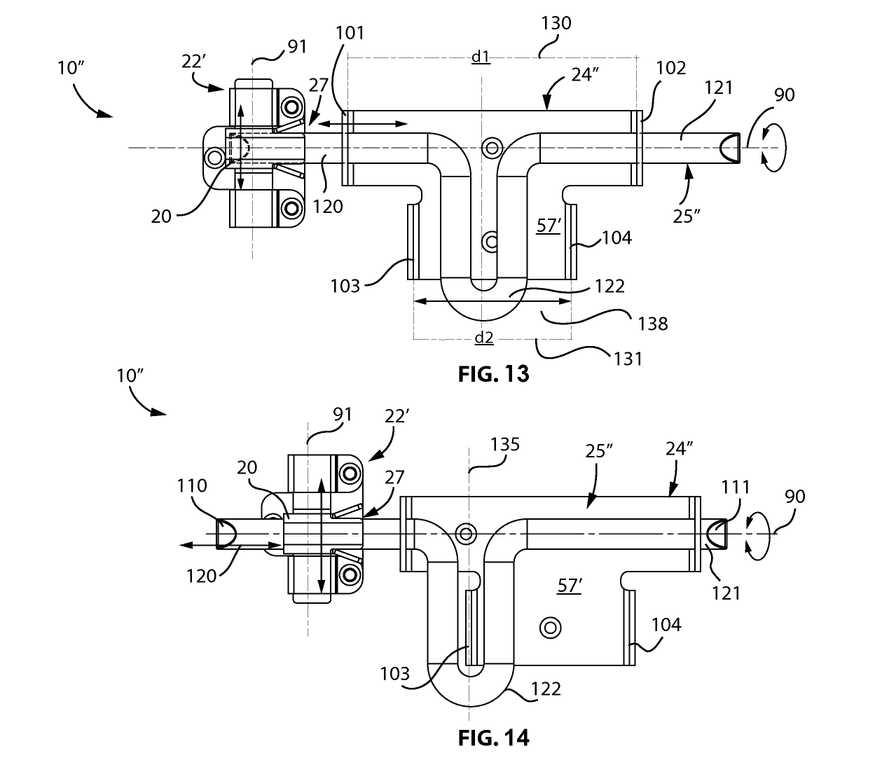

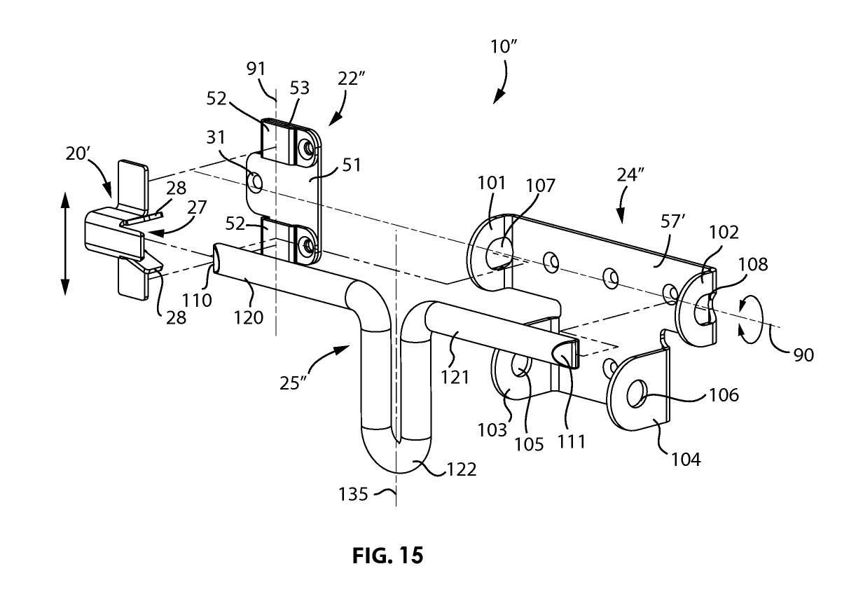

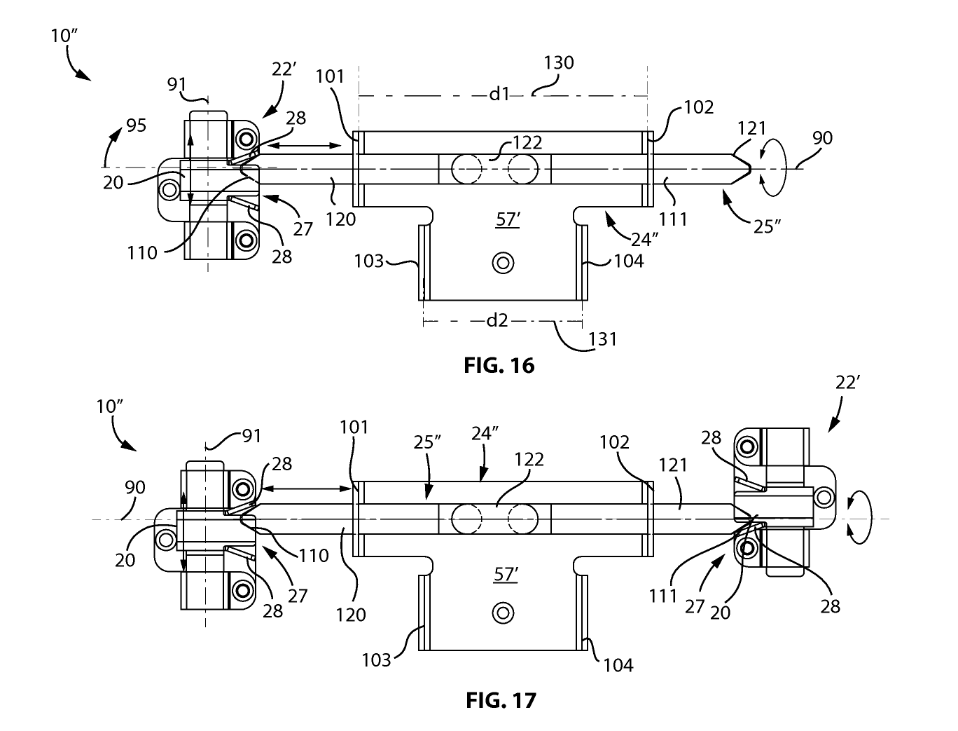

Now referring generally to FIGS. 11-17, a non-limiting exemplary embodiment of the present disclosure is illustrated wherein an adjustable door lock 10″ includes a catch plate 22′, a catch 20 having a channel 27 wherein the catch 20 is adjustably communicated with the catch plate 22′, a support plate 24″, and a locking bolt 25″ in communication with the support plate 24″ wherein the locking bolt 25″ is reciprocated along a first path 90 traveling along the support plate 24″ and the channel 27. Advantageously, as the locking bolt 25″ ingresses the channel 27, the catch 20 is automatically adjusted (e.g., dynamic, movable) along a second path 91 registered non-parallel to the first path 90 such that the channel 27 is automatically aligned with the first path 90.

It is noted that if catch plate 22′ is statically affixed to a door, support plate 24″ may be statically affixed to a support wall (e.g., door frame, etc.), and visa-versa. In other words, the catch plate 22′ and support plate 24″ are statically affixed at either the door or support wall (e.g., door frame, etc.), respectively. Furthermore, it is noted that the term “non-parallel” second path 91 may be defined as a direction that is orthogonal to the first path 90 or otherwise oblique to the first path 90. For example, if first path 90 is defined along an x-axis, the second path 91 may be defined along a y-axis, a z-axis or some other axis that is obliquely offset (e.g., not 90 degrees) from the x-axis.

In a non-limiting exemplary embodiment, the first path 90 is linear.

In a non-limiting exemplary embodiment, the second path 91 is linear.

In a non-limiting exemplary embodiment, the catch plate 22′ has a body 51 and a plurality of flanges 52 positioned on an exterior face of the body 51 such that a corresponding gap 53 is formed between the body 51 and each of the flanges 52, respectively.

In a non-limiting exemplary embodiment, the catch 20 is selectively interfitted through at least of one of the gaps 53 (e.g., along second path 91) while the channel 27 is automatically aligned with the first path 90.

In a non-limiting exemplary embodiment, the locking bolt 25″ includes a first portion (either 110, 120 or a combination thereof) and a second portion (either 111, 121 or a combination thereof) spaced therefrom wherein the first portion (either 110, 120 or a combination thereof) and second portion (either 111, 121 or a combination thereof) are aligned along the first path 90. As shown, 110, 111 may be chamfered (beveled) tips that guide locking bolt 25″ into channel 27. An intermediary portion 122 is engaged with the first portion (either 110, 120 or a combination thereof) and the second portion (either 111, 121 or a combination thereof). Such an intermediary portion 122 is offset from the first path 90 and provided with a centrally registered longitudinal axis 135 registered substantially orthogonal to the first path 90. Of course, intermediary portion 122 may have a curvilinear shape, square shape or some other non-linear shape that is capable of traveling around stops 103, 104, described hereinbelow.

In a non-limiting exemplary embodiment, the support plate 24″ includes a wall 57′, a first flange 101 and a second flange 102 outwardly extending from the wall 57′ and traversing the first path 90. The first flange 101 has a first aperture 107 and the second flange 102 has a second aperture 108 axially opposed from the first aperture 107. In this manner, the first aperture 107 and the second aperture 108 receive the first portion (either 110, 120 or a combination thereof) and the second portion (either 111, 121 or a combination thereof) of the locking bolt 25″, respectively, thereby guiding locking bolt 25″ along the first path 90. A first stop 103 and a second stop 104 outwardly extend from the wall 57′ wherein each of the first stop 103 and the second stop 104 traverse a travel path 138 (e.g., second distance 131) of the intermediary portion 122 when the locking bolt 25″ is disposed at a vertically lowered position. It is noted that vertically lowered position is defined as a lowered position that prevents the intermediary portion 122 from sliding beyond first and second stops 103, 104. The term “vertically lowered” should not be necessarily construed as planar with wall 57′.

In a non-limiting exemplary embodiment, the intermediary portion 122 has a curvilinear shape at least partially positioned along one of the first stop 103 and the second stop 104. As noted above, the intermediary portion 122 may have alternate shapes so long as it sits along first and second stops 103, 104 in such a manner that a conventional fastener (e.g., pad lock, not shown) is positional through first or second apertures 105, 106, thereby preventing articulation of the intermediary portion 122 towards first path 90.

In a non-limiting exemplary embodiment, the locking bolt 25″ is selectively rotated about an axis 95 aligned with the first path 90 such that the intermediary portion 122 is selectively articulated away from the first stop 103 and the second stop 104, when a fastener is not attached to the first or second stops 103, 104.

In a non-limiting exemplary embodiment, the intermediary portion 122 is at locked and unlocked positions when registered substantially parallel and substantially orthogonal to the wall 57′, respectively. Again, use of the terms “parallel” and “orthogonal” should not be construed as limited to only ninety degree offset positions so long as the intermediary portion 122 is able to clear the first and second stops 103, 104 during reciprocation along travel path 138.

In a non-limiting exemplary embodiment, the first flange 101 and the second flange 102 are spaced apart by a first distance (d₁) 130. The first stop 103 and second stop 104 are spaced apart by a second distance (d₂) 131. Notably, the first distance (d₁) 130 does not equal the second distance (d₂) 131.

In a non-limiting exemplary embodiment, when the intermediary portion 122 is registered substantially orthogonal to the wall 57′, the intermediary portion 122 is freely reciprocated along an entire length of the first distance (d₁) 130. The same above-referenced definition of “orthogonal” applies to this structure.

In a non-limiting exemplary embodiment, when the intermediary portion 122 is registered substantially parallel to the wall 57′ and below the first flange 101 and second flange 102, the intermediary portion 122 is freely reciprocated along the second distance (d₂) 131 and prohibited from traveling along the entire length of the first distance (d₁) 130.

In a non-limiting exemplary embodiment, the first path 90 is bi-directional and oriented along a horizontal plane (e.g., substantially orthogonal to wall 57′) while the second path 91 is bi-directional and oriented along a vertical plane (e.g., substantially parallel to wall 57′).

In a non-limiting exemplary embodiment, the locking bolt 25″ linearly traverses the second path 91 upon ingressing and egressing the channel 27 respectively.

In a non-limiting exemplary embodiment, the catch flanges 52 remain statically mated to the catch plate 22′ as the catch 20 is displaced along the second path 91.

In a non-limiting exemplary embodiment, the catch 20 includes a plurality of guides 28 diverging away from the channel 27 towards the support plate 24″ for guiding the locking bolt 25″ along the channel 27.

In a non-limiting exemplary embodiment, the guides 28 converge towards the channel 27 away from the support plate 24″ for guiding the locking bolt 25″ along the channel 27.

The present disclosure further includes a method for using an adjustable door lock 10″ for locking a misaligned or off-set door relative to a support wall (e.g., dry wall, door frame, etc.) adjacent to the door. Such a method includes the steps of: providing a catch plate 22′; providing a catch 20 having a channel 27; adjustably communicating the catch 20 with the catch plate 22′; providing a support plate 24″; and providing and communicating a locking bolt 25″ with the support plate 24″.

The method further includes the steps of: reciprocating the locking bolt 25″ along a first path 90 traveling along the support plate 24″ and the channel 27; and the locking bolt 25″ ingressing the channel 27 and thereby automatically adjusting the catch 20 along a second path 91 registered non-parallel to the first path 90 such that the channel 27 automatically aligns with the first path 90.

Notably, the door lock 10, 10′ and 10″ advantageously allows the catch 20, 20′ and the locking bolt 25, 25′, 25″ to be automatically adjusted to compensate for any misalignment of the door relative to a support surface during extended use.

While the disclosure has been described with respect to a certain specific embodiment, it will be appreciated that many modifications and changes may be made by those skilled in the art without departing from the spirit of the disclosure. It is intended, therefore, by the appended claims to cover all such modifications and changes as fall within the true spirit and scope of the disclosure. In particular, with respect to the above description, it is to be realized that the optimum dimensional relationships for the parts of the present disclosure may include variations in size, materials, shape, form, function and manner of operation.

What is claimed as new and what is desired to secure by Letters Patent of the United States is:

1. An adjustable door lock for locking a misaligned or off-set door relative to a support wall adjacent to the door, said adjustable door lock comprising:
a stationary catch plate;
a dynamic catch having a channel, said catch being adjustably communicated with said catch plate;
a support plate; and
a locking bolt in communication with said support plate and reciprocated along a first path traveling along said support plate and said channel;
wherein, as said locking bolt ingresses said channel, said catch is automatically adjusted along a second path registered substantially orthogonal to said first path such that said channel is automatically aligned with said first path.

2. An adjustable door lock for locking a misaligned or off-set door relative to a support wall adjacent to the door, said adjustable door lock comprising:
a catch plate;
a catch having a channel, said catch being adjustably communicated with said catch plate;
a support plate; and
a locking bolt in communication with said support plate and reciprocated along a first path traveling along said support plate and said channel;
wherein, as said locking bolt ingresses said channel, said catch is automatically adjusted along a second path registered non-parallel to said first path such that said channel is automatically aligned with said first path.

3. The adjustable door lock of claim 2, wherein said first path is linear.

4. The adjustable door lock of claim 2, wherein said second path is linear.

5. The adjustable door lock of claim 2, wherein said catch plate has a body and a plurality of flanges positioned on an exterior face of said body such that a corresponding gap is formed between said body and each of said flanges, respectively.

6. The adjustable door lock of claim 5, wherein said catch is selectively interfitted through at least of one of said gaps while said channel is automatically aligned with said first path.

7. The adjustable door lock of claim 2, wherein said locking bolt comprises:
a first portion and a second portion spaced therefrom, said first portion and said second portion being aligned along said first path; and
an intermediary portion engaged with said first portion and said second portion, said intermediary portion being offset from said first path and provided with a centrally registered longitudinal axis registered substantially orthogonal to said first path.

8. The adjustable door lock of claim 7, wherein said support plate comprises:
a wall;
a first flange and a second flange outwardly extending from said wall and traversing said first path, said first flange having a first aperture and said second flange having a second aperture axially opposed from said first aperture, said first aperture and said second aperture receiving said first portion and said second portion of said locking bolt, respectively; and
a first stop and a second stop outwardly extending from said wall, each of said first stop and said second stop traversing a travel path of said intermediary portion when said locking bolt is disposed at a vertically lowered position.

9. The adjustable door lock of claim 8, wherein said intermediary portion has a curvilinear shape at least partially positioned along one of said first stop and said second stop.

10. The adjustable door lock of claim 8, wherein said locking bolt is selectively rotated about an axis aligned with said first path such that said intermediary portion is selectively articulated away from said first stop and said second stop.

11. The adjustable door lock of claim 7, wherein said intermediary portion is at locked and unlocked positions when registered substantially parallel and substantially orthogonal to said wall, respectively.

12. The adjustable door lock of claim 8, wherein said first flange and said second flange are spaced apart by a first distance, wherein said first stop and second stop are spaced apart by a second distance; wherein said first distance does not equal said second distance.

13. The adjustable door lock of claim 11, wherein, when said intermediary portion is registered substantially orthogonal to said wall, said intermediary portion is freely reciprocated along an entire length of said first distance.

14. The adjustable door lock of claim 12, wherein, when said intermediary portion is registered substantially parallel to said wall, said intermediary portion is freely reciprocated along said second distance and prohibited from traveling along said entire length of said first distance.

15. The adjustable door lock of claim 2, wherein said first path is bi-directional and oriented along a horizontal plane while said second path is bi-directional and oriented along a vertical plane.

16. The adjustable door lock of claim 2, wherein said locking bolt linearly traverses said second path upon ingressing and egressing said channel respectively.

17. The adjustable door lock of claim 5, wherein said catch flanges remain statically mated to said catch plate as said catch is displaced along said second path.

18. The adjustable door lock of claim 2, wherein said catch comprises:
a plurality of guides diverging away from said channel towards said support plate for guiding said locking bolt along said channel.

19. The adjustable door lock of claim 18, wherein said guides converge towards said channel away from said support plate for guiding said locking bolt along said channel.

20. A method for using an adjustable door lock for locking a misaligned or off-set door relative to a support wall adjacent to the door, said method comprising the steps of:
providing a catch plate;
providing a catch having a channel;
adjustably communicating said catch with said catch plate;
providing a support plate;
providing and communicating a locking bolt with said support plate;
reciprocating said locking bolt along a first path traveling along said support plate and said channel; and
said locking bolt ingressing said channel and thereby automatically adjusting said catch along a second path registered non-parallel to said first path such that said channel automatically aligns with said first path.
